(19) United States
(12) Patent Application Publication
(10) Pub. No.: US 2006/0191218 A1
(43) Pub. Date: Aug. 31, 2006

(54) Floor covering having a removable decorative inlay

(76) Inventor: Joseph Rocco Pacione, Newmarket (CA)

Correspondence Address: MCCARTHY TETRAULT LLP, BOX 48, SUITE 4700,, 66WELLINGTON STREET WEST, TORONTO, ON, M5K 1E6, CA

(21) Appl. No.: 10/543,903

(22) PCT Filed: Jan. 29, 2004
(86) PCT No.: PCT/CA04/00123

§ 371 Date: Jul. 29, 2005

(30) Foreign Application Priority Data
Jan. 30, 2003 (US) 60443578

(51) Int. Cl. E04H 1/00

(52) U.S. Cl. 52/234

(57) ABSTRACT

A floor covering containing a decorative pattern is described. The floor covering has a field of hooks substantially covering a floor to receive decorative overlaid pieces. The covering further has a carrier sheet comprising a top side substantially covered in hooks, such hooks being one half of a hook and loop attachment system, and a bottom side substantially covered in loops, such loops being a second half of a hook and loop attachment system. The carrier sheet is detachably attached by its loops to the field of hooks. The covering further has a first set of decorative pieces having a bottom side substantially covered in loops, such being one half of a hook and loop attachment system. The set of decorative pieces are detachably attached to the upper surface of the carrier sheet and comprise a visually distinct design sheet which substantially entirely fills the upper surface of the carrier sheet. Furthermore, the covering has a second set of decorative pieces having a bottom side substantially covered in loops, such loops being one half of a hook and loop attachment system, which are detachably attached to the field of hooks to fill the space around the set of decorative pieces.

### FIELD OF THE INVENTION

This invention relates to a covering for a floor, in which the covering has a removable decorative inlay. The decorative inlay has a looped underside for attachment to a field of hooks. The inlay itself is composed of a plurality of decorative pieces which are attached to a carrier sheet which is itself secured by a hook and loop attachment system to an underlying anchor sheet or other floor containing a field of hooks. The decorative pieces may be attached to the carrier sheet by a hook and loop attachment system.

### BACKGROUND OF THE INVENTION

Over the past several years, attempts have been made at incorporating hook and loop (Velcro (TM)) technology into floor coverings, particularly carpeting. There are several advantages to the use of such technology. It is environmentally friendly, permitting connection of flooring components in situ without the use of glues that release volatile organics. Hook and loop technology provides a robust connection, but one that is at the same time releasable, presenting advantages during installation and permitting replacement of damaged pieces, etc.

An example of the use of hook and loop technology in the field of carpets is described in U.S. Pat. No. 4,822,658, which issued to Pacione on Apr. 14, 1989. The specification of this patent shows a carpet having loops across its underside for attachment along its edges by means of hooked strips secured to a floor to be covered by the carpet.

Hook and loop attachment systems, in respect of flooring, provide an opportunity for creation of carpet units from multiple pieces to create interesting designs.

More recently, use of anchor sheets to cover, more or less, an entire area to be carpeted has been described in U.S. Pat. No. 6,306,477, which issued to Pacione on Oct. 23, 2001. Such an anchor sheet is described in a more detailed way in international patent application No. PCT/CA 00/00681, that was published under WO 00/74544 on Dec. 14, 2000, and names Pacione as the inventor. Each of these cases describes a final carpet construction in which multiple carpet pieces are attached across the surface of an underlayment made up of multiple anchor sheets. The present invention relates to this sort of arrangement.

### SUMMARY OF THE INVENTION

The present invention in one aspect, is a floor covering containing a removable decorative inlay. The decorative inlay is attached to a field of hooks which substantially covers a floor to receive the decorative inlay. The decorative inlay is formed from a carrier sheet, comprising a bottom side substantially covered in loops, the carrier sheet is detachably attached by its loops to the field of hooks. Attached to the carrier sheet, is a first set of at least five decorative pieces which comprises a visually distinct design that substantially entirely fills the upper surface of the carrier sheet. There is a second set of decorative pieces having a bottom side substantially covered in loops detachably attached to the field of hooks to fill the space around the set of decorative pieces.

In one preferred embodiment, the first set of decorative pieces are carpet pieces, and the second set of decorative pieces are also carpet pieces. The first set in additional aspects of the invention, usually comprises groupings of carpet pieces, often in intricate patterns, to create coats of arms, pictures, ornamental medallions, and any other intricate and complicated form of design.

In this way, in the preferred embodiment, the invention is ideally suited for complicated designs which can be pre-installed on a carrier sheet in a factory or other location, transported to a site to be installed as a design element into a field of hooks at a flooring site.

In other aspects of the invention, the design could be carpet, ceramic, stone, metal, or wood, which can be installed onto the carrier sheet using a hook and loop attachment system or permanently installed on the carrier sheet so that such a design can be inset into a larger field of carpet or other material that has been installed on the field of hooks.

In another aspect of the invention, the decorative pieces (for instance carpet) installed on the carrier sheet, can be of the same height of the decorative pieces in the surrounding “fill” and are installed directly onto the field of hooks. In this way, the decorative inlay will be very slightly raised above the surface of the surrounding carpet materials. In another aspect of the invention, the inlay can be of a thinner or thicker material than the surrounding “fill”, thereby creating other design possibilities.

Related to the invention(s) disclosed herein are invention(s) in the following United States provisional patent applications:

United States Provisional Patent Application entitled “Carpet tile, installation, and methods of manufacture and installation thereof”, filed concurrently herewith and incorporated herein by reference; United States Provisional Patent Application entitled “System and methods of manufacturing hook-plates”, and filed concurrently herewith;

United States Provisional Patent Application entitled “Improved anchor sheet”, and filed concurrently herewith;

United States Provisional Patent Application entitled “Ultrasonic welding of resilient layers to plates”, and filed concurrently herewith; and

United States Provisional Patent Application entitled “Anchor sheet positioning and connection system”, and filed concurrently herewith.

### BRIEF DESCRIPTION OF THE DRAWINGS

Particular embodiments of the invention are described below with reference to the accompanying drawings, in which:

FIG. 1 shows a prior art floor tile that includes multiple carpet pieces attached to a carrier sheet;

FIG. 2 shows an installation of a decorative inlay of the present invention attached to a field of hooks created by an anchor sheet subfloor;

FIG. 3 shows an installation in which the decorative inlay of FIG. 2 has carpet pieces as surrounding “fill” attached to the field of hooks created by a number of anchor sheets;

FIG. 4 shows a cross-section of the installation of FIG. 3 taken along line 4-4 of FIG. 3;

FIG. 5 is a sectional type view of a preferred carpet construction for use with the present invention;

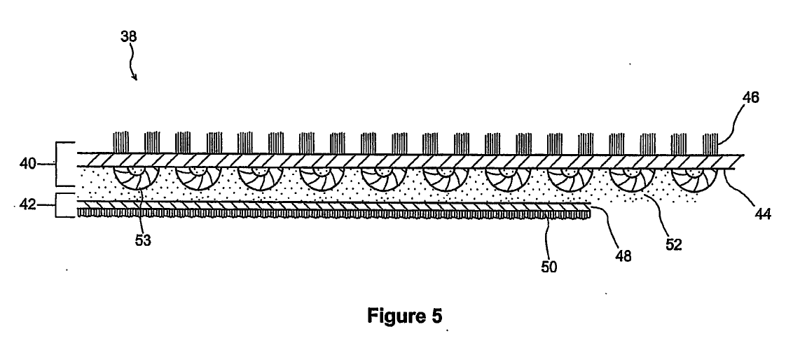

FIG. 6 is a sectional type view of a preferred carrier sheet for use with the present invention;

FIG. 7 is a sectional type view of a preferred anchor sheet for use with a carrier sheet.

### DETAILED DESCRIPTION OF THE INVENTION

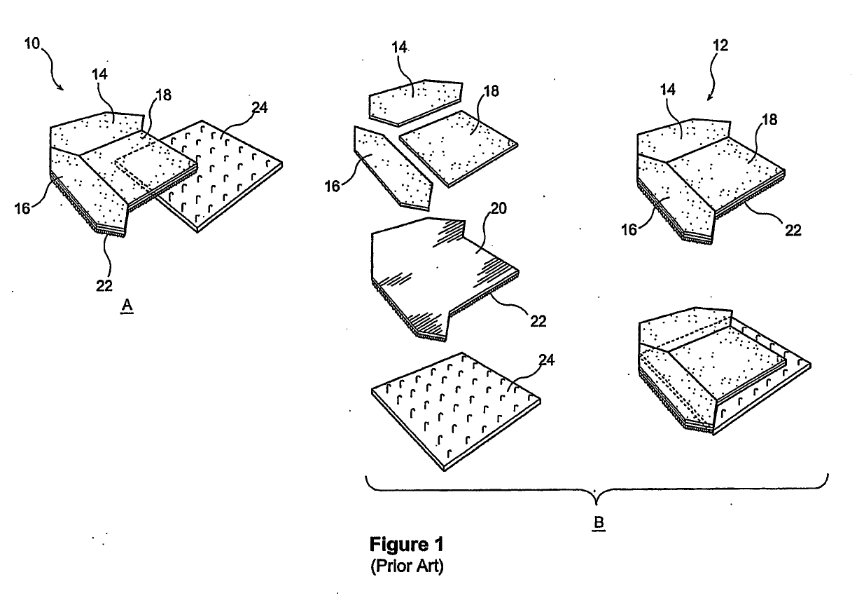

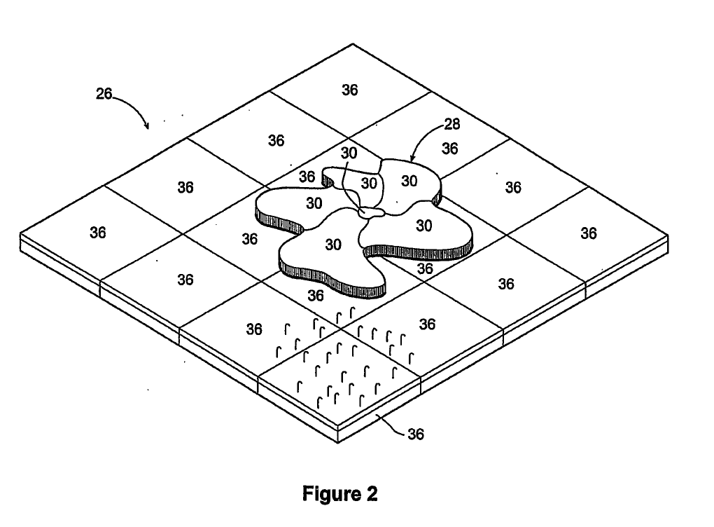

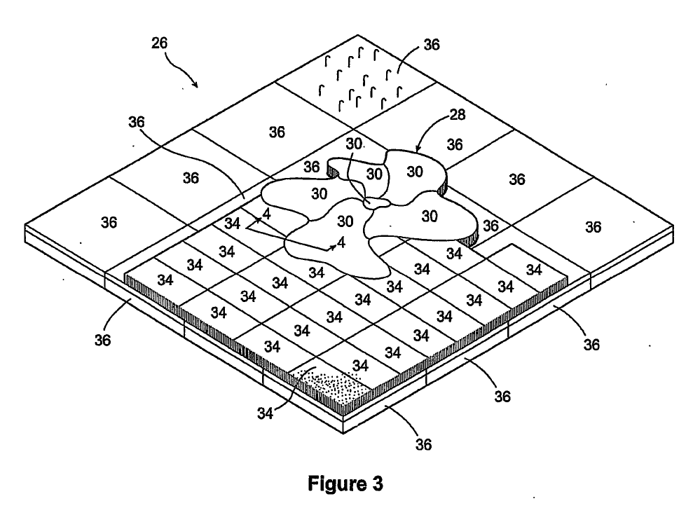

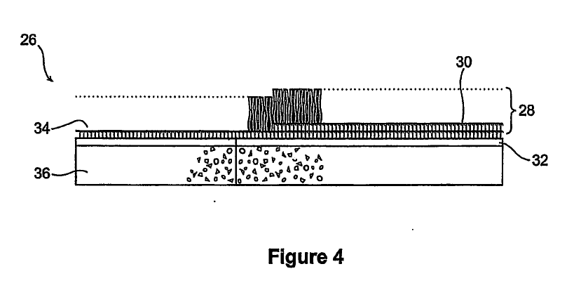

Turning to the drawings, FIG. 1 shows prior art carpet tiles 10, 12. This drawing is based on FIG. 29 contained in the specification of U.S. Pat. No. 6,298,624, which issued on Oct. 9, 2001 to the inventor named herein, incorporated herein by reference. Each tile includes multiple carpet pieces 14, 16, 18 which are assembled onto carrier sheet 20, having loops 22 on its underside, to create a unit for installation onto piece 24. This creates a module as shown in FIG. 1B, that can be used and installed in an overlapping fashion with other modules as shown in the '624 Patent. One aspect of the present invention is shown in FIGS. 2, 3, and 4. In this case, a carpet installation, 26 is shown. It includes a decorative inlay 28 in one preferred embodiment carpet installation. The inlay is made up of carpet pieces 30 attached to carrier sheet 32. The decorative inlay 28 is formed from carpet pieces 30 and carrier sheet 32 is attached to the field of hooks created by anchor sheets 36. Carrier sheet 32 is relatively thin in relation to the thickness of carpet pieces 30 and 34 and cannot readably be seen in FIGS. 2 and 3, but can be seen in FIG. 4. Carpet pieces 34 provide the “fill” or background to the decorative inlay 28 and are installed directly onto the hooks of the anchor sheet.

Carpet pieces 30 and 34 can be made as the same construction as each other, or of a different construction from each other. If the carpet pieces are made of the same size and weight, then the decoration can appear to be an integral part of the overall carpet. Because carrier sheet 32 is of a relatively low profile in relation to the thickness of the carpet, the decorative inlay 28 will only be very slightly raised above the surrounding “field”. This slight raising of decorative inlay 28 can help to offset the design and can be visually attractive. The height will not be sufficient to create an impediment to walking.

Alternatively, carpet pieces 30 and 34 can be made different heights, so that the decorative piece is at the same height as the “field” created by carpet pieces 34, or is sunken in relation to carpet pieces 34.

Further alternatively, the decorative pieces 30 can be made of any other material, preferred for the matter, such as stone, ceramic, marble, or even metal. In a preferred form, the decorative pieces are provided with a loop backing and the carrier sheet has a top side covered in hooks.

Further alternatively, the decorative pieces can be permanently attached to the carrier sheet. Since the carrier sheet will have loops on the back for detachable attachment to the underlying field of hooks, the permanent attachment of pieces 30 to the carrier sheet 32 is not of concern, as presumably the decorative inlay operates as a stand alone separate unit that can be moved, transported and reinserted in another background or field as desired.

In one preferred embodiment, the carpet is constructed in accordance with the carpet construction shown in the above-detailed application entitled “Carpet Tile, Installation, and Methods of Manufacture.” Typically, such carpet is a laminate made up of an upper first layer 40 and a lower second layer 42. The first layer 40 of the carpet includes a nonwoven primary backing 44 into which is needle pile yarn 46. Second layer 42 includes secondary backing 48 to which are attached lower loops 50. The layers are secured to each other by hot melt adhesive 52.

Again, typically the primary backing 44 is a nonwoven fabric. Pile yarn 46 is tufted into primary backing 44.

One preferred secondary layer 42 is a tricot knit, supplied by Guilford Mills, Inc. of Greensboro, N.C. Typically, such a tricot knit forms a dense substrate which provides for loops 50 on the underside of the secondary backing 48, which tricot precludes most, if not all, bleeding of hot melt 52 into the loops. Excessive bleeding, of course, is to be avoided as this could interfere with the function of the loops as fasteners.

First and second layers 40, 42 are attached to each other by hot melt layer 52 which also encapsulates tufts 53. One particular adhesive used is an ethylene-vinyl acetate-based adhesive known as XP-025 provided by Barrier-Bac, Inc. of Calhoun, Ga. The adhesive is substantially free of filler, organic and inorganic. The overall weight of the carpet of the present invention is approximately 80-100 oz per square yard. It will thus be appreciated that it is possible, according to the invention, to have a carpet, and carpet tile, with a relatively lightweight secondary backing. Such a backing lacks a stabilizing layer and, as is explained below, is relatively free of filler. Such a carpet or carpet tile has little or no inherent dimensional stability of its own in relation to externally applied physical forces, such as stretching forces, forces exerted in use by rolling machinery, furniture movement, etc.

The carpet laminate can eventually be cut into tiles at some convenient point. This enables a decorative inlay to be created from numerous carpet pieces. Such pieces installed on a carrier sheet in a factory or other location, can have a complicated pattern, but, as they exist as a self-contained unit on the carrier sheet, can be transported to a site, and installed separately. They can also be removed when a change is desired.

With the carpet described above, combined with a field of hooks, it is possible to make a carpet tile of any shape and size to order. Even small carpet tiles, i.e. 2″×2″ can be easily incorporated into carpet installation. The carpet laminate can be cut through the back or the front by, for example, an ultrasonic cutting cutter on a plotting table. The cutter can be controlled by software to make any form of pattern or design.

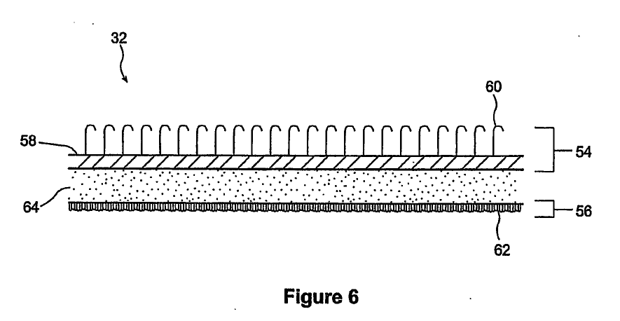

Carrier sheet 32 is illustrated separately in FIG. 6. Carrier sheet includes upper layer 54 and lower layer 56. Upper layer 54, manufactured of polypropylene, includes base sheet 58 and hooks 60 across the upper side of the sheet. The whole carrier sheet is designed to carry a number of individual pieces to form a decorative inlay. Generally speaking, it is desired to have the profile as thin as possible, so as not to raise the decorative inlay above the surrounding “field” or background, other than a small amount to perhaps create a slight visual effect without impairing the ability of a person or persons to walk over the decorative inlay, which would be desirable in most instances.

One particular carrier sheet of the invention includes two extruded sheets of polypropylene, which are secured together by a hot melt, typically EVA hot melt. The thickness of each two extruded sheets (not taking into account hooks and loops) is about 0.3 mm, and the bonding layer is about 0.1 mm. There are alternatives to these sheets commercially available. Lower layer 56 of the carrier sheet provides the carrier sheet with loops 62 across the underside of the sheet. Layer 56 has the same tricot construction of second layer 42 of carpet 36 described above. Layers 54 and 56 are secured to each other by EVA hot melt 64.

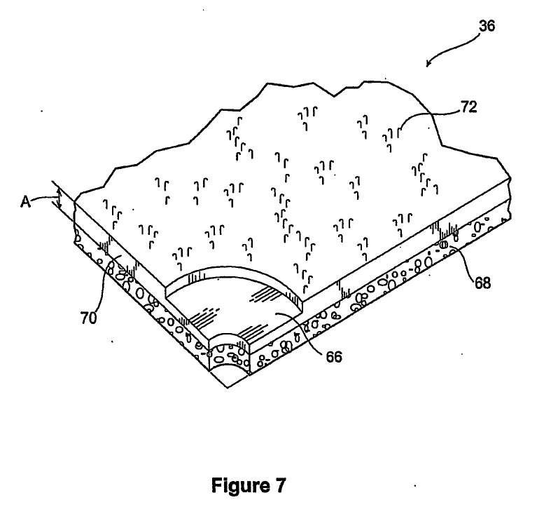

Anchor sheet 36 is illustrated separately in FIG. 7. The preferred embodiment is manufactured in accordance with the description provided in the above-detailed applications entitled “System and methods of Manufacturing hook-plates” and “Improved anchor sheet”. The thickness of anchor sheet A is about ⅛ inches, and the thickness of the anchor sheet at 66 is about 1/16 inches. The corner of the anchor sheet includes a counter sunk area attachment, for attaching, if desired, to other anchor sheets, or to an underlying floor, as described in WO 0/74544 published Dec. 14, 2000. The anchor sheet 36 includes a cushion 68 of thickness that can be either approximately ¼ inches, or ⅜ inches depending on the desired resiliency and the amount of surface traffic. The hooks 72 of the top surface layer 70 will have a density that may range from 160-1200 hooks/square inch, with a preferred density of approximately 230 hooks/square inch.

The preferred material for the top surface layer 70 is polypropylene and the cushion 68 is polyethylene. In a preferred embodiment, the cushion 68 is made from linear load density polyethylene with a density of approximately 30 kg/m³.

With the floor covering having a decorative inlay formed by an additional carrier sheet, complicated decorative inlays can be pre-made and installed into a surrounding field or background.

Such decorative inlays can be moved or replaced to change the look of a floor immediately and inserted and removed to provide personalized features, such as a family crest or favourite theme or topic. Decorative inlays can easily be sold as a unit for insertion into a surrounding field of hooks and can appeal to particular categories of consumers, children, sports fans, music lovers, or virtually any category where a specific design can be incorporated into a carpet or other decorative inlay as desired.

The invention disclosed in this preferred embodiment is just one aspect of the invention which is intended to be defined by the claims which follow.

1. A floor covering containing a decorative pattern comprising:
(i) a field of hooks substantially covering a floor to receive decorative overlaid pieces;
(ii) a carrier sheet comprising a top side substantially covered in hooks (being one half of a hook and loop attachment system) and a bottom side substantially covered in loops (being a second half of a hook and loop attachment system), the carrier sheet detachably attached by its loops to the field of hooks;
(iii) a first set of at least five decorative pieces having a bottom side substantially covered in loops being one half of a hook and loop attachment system, the set of decorative pieces detachably attached to the upper surface of the carrier sheet and comprising a visually distinct design sheet substantially entirely filling the upper surface of the carrier sheet, and
(iv) a second set of decorative pieces having a bottom side substantially covered in loops (being one half of a hook and loop attachment system), detachably attached to the field of hooks to fill the space around the set of decorative pieces.

2. The floor covering of claim 1 in which the carrier sheet is of a thickness substantially less than the thickness of the decorative pieces.

3. The floor covering of claim 2 in which the first and second set of decorative pieces are of the same thickness.

4. The floor covering of claim 3 in which the second set of decorative pieces is carpet.

5. The floor covering of claim 4 in which the first set of decorative pieces is carpet.

6. The floor covering of claim 5 in which the first set of decorative pieces is wood, ceramic, stone, or metal.

7. The floor covering of claim 2 in which the thickness of the first set of pieces is less than the second set of pieces by an amount which substantially equals the thickness of the carrier sheet.

8. The floor covering of claim 6 in which the first set of decorative pieces is carpet.

9. The floor covering of claim 7 in which the second set of decorative pieces is carpet, wood, ceramic, stone, or metal.

10. The floor covering of claim 8 in which the carrier sheet has a thickness of from 0.2 mm to 2 mm.

11. A method of creating a floor covering having decorative inlays comprising:
(i) laying a field of hooks on a floor;
(ii) assembling at least five decorative pieces having a bottom side substantially covered in loops onto a hooked surface of a carrier sheet having a top surface of hooks and a bottom surface of loops to create a design;
(iii) detachably attaching the carrier sheet unto a field of hooks;
(iv) attaching a plurality of pieces having a bottom side substantially covered in loops onto the field of hooks surrounding the carrier sheet to create a field or background for the design on the carrier sheet.

12. A floor covering containing a decorative pattern comprising:
(i) a field of hooks substantially covering a floor to receive decorative overlaid pieces;
(ii) a carrier sheet comprising a bottom side substantially covered in loops of a hook and loop attachment system, the carrier sheet detachably attached by its loops to the field of hooks;
(iii) a first set of at least five decorative pieces, the set of decorative pieces attached to the upper surface of the carrier sheet and comprising a visually distinct design sheet substantially entirely filling the upper surface of the carrier sheet, and
(iv) a second set of decorative pieces having a bottom side substantially covered in loops of the hook and loop attachment system, detachably attached to the field of hooks to fill the space around the set of decorative pieces.
